(19) United States
(12) Patent Application Publication
(10) Pub. No.: US 2014/0065277 A1
(43) Pub. Date: Mar. 6, 2014

(54) PRESS FOR MAKING A FOOTBALL SHAPED PRESSED FOOD

(71) Applicants: Clemente MICARA-SARTORI, Berwyn, PA (US); Michael W. DUNN, Glastonbury, CT (US)

(72) Inventors: Clemente MICARA-SARTORI, Berwyn, PA (US); Michael W. DUNN, Glastonbury, CT (US)

(73) Assignee: Aspiring Enterprises Inc, Berwyn, PA (US)

(21) Appl. No.: 13/605,733

(22) Filed: Sep. 6, 2012

(51) Int. Cl. A22C 7/00

(52) U.S. Cl. CPC A22C 7/0076
USPC 426/513; 425/318

(57) ABSTRACT

The invention features a press for making a football shaped pressed food that may include, e.g., a logo, insitodgnia, and/or indicium of a football, e.g., the laces, pebble-grain texture, and/or vertical stripes) imprinted therein or thereon, and methods and uses thereof.

### FIELD OF THE INVENTION

In general, the invention relates to a press for making a football shaped pressed food (e.g., a patty), and methods and uses thereof.

### BACKGROUND OF THE INVENTION

The use of meat presses is known in the prior art, and most are devised and utilized for the purpose of pressing foods into molded shapes. Most meat presses presently on the market are designed to form the meat into a round patty. Other presses are known to put weight on the meat in order to hold it down on the grill. These types of presses are typically designed to facilitate cooking of the meat, but often lack the ability to imprint a design on the meat or to create a desired shape other than a round patty in the meat before, during, and/or after cooking.

As will be appreciated, prior art meat presses do not provide for the formation of patties with the design and shape of a football, two features that would enhance the aesthetic appeal of food prepared by and for certain discriminating individuals. The use of such a press to prepare a food product would likely increase the consumption, enjoyment, and satisfaction of the food product by such individuals. In this regard, the present invention substantially fulfills this need.

### BRIEF SUMMARY OF THE INVENTION

The invention features a press for making a football shaped pressed food, including: a) a base, b) an opposing lid, and c) a handle or hand tab positioned on the lid for closing the lid onto the base, in which the base and/or lid are configured to mold a ground food into a football shape during pressing.

In one aspect of the invention, the press for making a football shaped pressed food further includes a hinge connecting the lid and the base. In another aspect of the invention, the base and/or lid of the press further includes an interior surface that includes an imprint that imparts one or more of the following designs onto a surface of the ground food during pressing: a sports logo, laces of a football, vertical stripes of a football, and/or a pebble-grain texture. In yet another aspect, the base is adjustable to allow for variations in the amount and/or thickness of the football shaped pressed food.

In an embodiment, the press is made from a food safe material (e.g., the food safe material is selected from the group consisting of plastic, cast aluminum, stainless steel, and metal alloys). In another embodiment, the press is dishwasher safe. In other embodiments, the press produces the football shaped pressed food having a uniform size; the thickness of the football shaped pressed food is less than or up to 1 ½ inches; the football shaped pressed food is sized to fit a commercial bun; and/or the football shaped pressed food is a patty.

In an embodiment of all aspects of the invention, the ground food is selected from the group consisting of meats, seafood, vegetables, rice products, flour products, and any combinations or mixtures thereof. In another aspect of the invention the ground food includes beef, turkey, chicken, veal, goat, fish, shrimp, crab, salmon, lentils, beans, carrots, potatoes, yams, pumpkin, eggplant, cauliflower, chickpea, onions, garlic, radish, white rice, brown rice, wild rice, glutinous rice, basmati rice, short grain rice, long grain rice, broken rice, black rice, wheat flour, bread flour, rice flour, corn flour, buckwheat flour, potato flour, cake flour, soy flour, self-rising flour, or rye flour.

In some embodiments, the pressed food is a tartare or a baked good. In other embodiments, the pressed food is a steak tartare, a venison tartare, a tuna tartare, a salmon tartare, a chicken tartare, a goat tartare, an eel tartare, a sole tartare, a smelt tartare, a lamb tartare, a cookie, cake, muffin, pancake, waffle, bun, turnover, or a pie. In yet another embodiment, the football shaped pressed food further includes a filling material.

In an embodiment of all aspects of the invention, the press is shaped and/or designed to resemble a football.

The invention also features a method for making a football shaped food patty, including: a) placing the ground food in the press for making a football shaped pressed food, including a base, an opposing lid, and a handle or hand tab positioned on the lid for closing the lid onto the base, and b) compressing the ground food between the base and lid of the press to form the football shaped pressed food.

### BRIEF DESCRIPTION OF THE DRAWINGS

FIG. 1 is a top perspective view of an unhinged press embodying the invention showing the lid containing a top handle and a base.

FIG. 2 is a bottom perspective view of the unhinged press of FIG. 1 embodying the invention showing the bottom of the lid and base.

FIG. 3 is a left side view of the unhinged press of FIG. 1 embodying the invention.

FIG. 4 is a right side view of the unhinged press of FIG. 1 embodying the invention.

FIG. 5 is a front view of the unhinged press of FIG. 1 embodying the invention.

FIG. 6 is a rear view of the unhinged press of FIG. 1 embodying the invention.

FIG. 7 is a top view of the unhinged press of FIG. 1 embodying the invention showing the lid and base.

FIG. 8 is a bottom view of the unhinged press of FIG. 1 embodying the invention showing the lid and base.

FIG. 9 is a perspective view of the unhinged press of FIG. 1 embodying the invention, in which the lid containing a top handle is inserted into the base.

FIG. 10 is a perspective view of a hinged press embodying the invention with a lid and a base in which the lid includes a hand tab positioned in the front of the lid.

FIG. 11 is a perspective view of the bottom of the hinged press of FIG. 10 embodying the invention showing the bottom of the base.

FIG. 12 is a back elevation view of the hinged press of FIG. 10 embodying the invention with the lid in the open position showing the top of the lid with a hand tab positioned at the front of the lid and a hand pull positioned at the top of the lid.

FIG. 13 is a front elevation view of the hinged press of FIG. 10 embodying the invention with the lid in the open position showing the bottom of the lid.

FIG. 14 is a right side elevation view of the hinged press of FIG. 10 embodying the invention with the lid in the open position.

FIG. 15 is a left side elevation view of the hinged press of FIG. 10 embodying the invention with the lid in the open position.

FIG. 16 is a top view of the hinged press of FIG. 10 embodying the invention with the lid in the open position exposing the top of the base.

FIG. 17 is a bottom view of the hinged press of FIG. 10 embodying the invention with the lid in the open position exposing the bottom of the base.

### DETAILED DESCRIPTION OF THE INVENTION

### Components of the Football Shaped Press

The press includes a base and an opposing lid that are capable of moving toward each other in order to create a compressive force therebetween. The base and/or lid imparts a shape to a food, such as hamburger meat or other food suitable for formation as a pressed food (e.g., a patty), as is described herein, when closed and pressed together. Preferably, the pressed food is in the shape of a football.

The interior surface of the base and/or lid includes an imprint that imparts a design on the food when closed and pressed together. The imprint on the base and/or lid imparts a design, in particular a football design, to a food, such as hamburger meat or other food suitable for formation as a pressed food, such as a patty, as is described herein.

In a preferred embodiment, the press imparts both the design and shape of a football to the food (e.g., the design may be on one or both sides of the food). In an embodiment, the press imparts a design and shape on both sides of the food. Preferably, the base of the press includes the design to be imprinted onto the pressed food, but either the base or lid or both may have the imprint protruding from its surface in order to impart the design onto the pressed food.

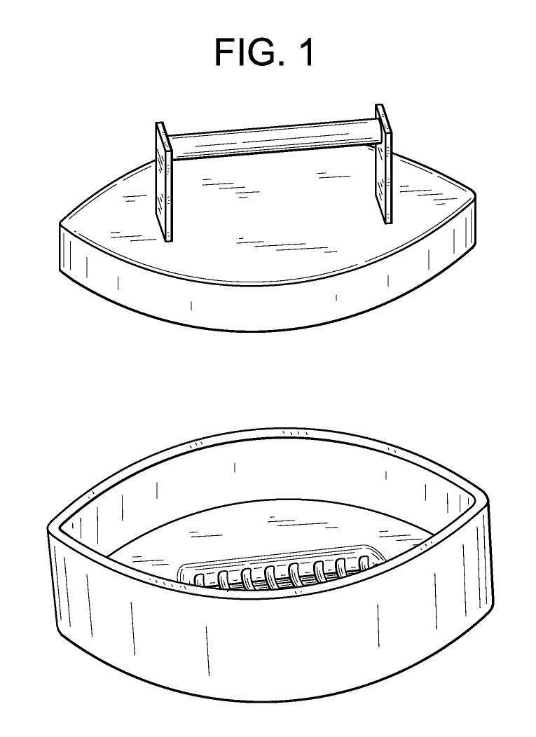

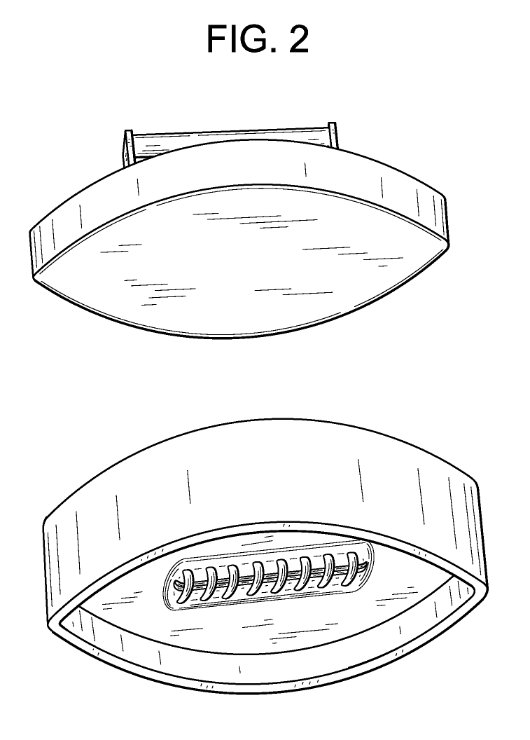

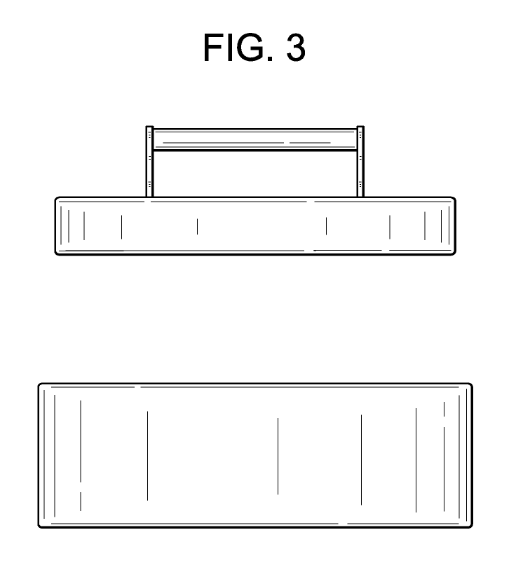

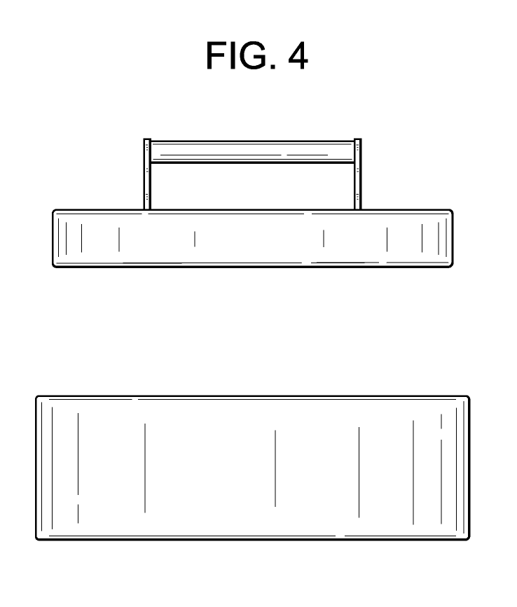

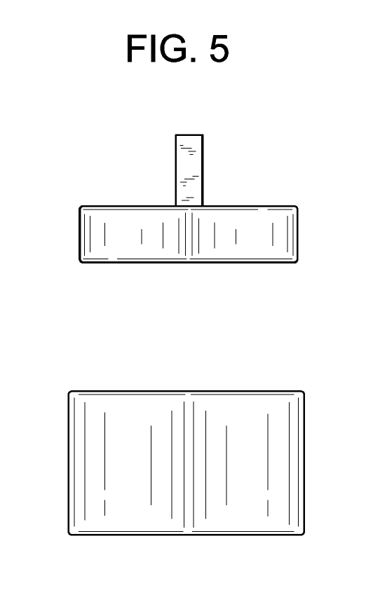

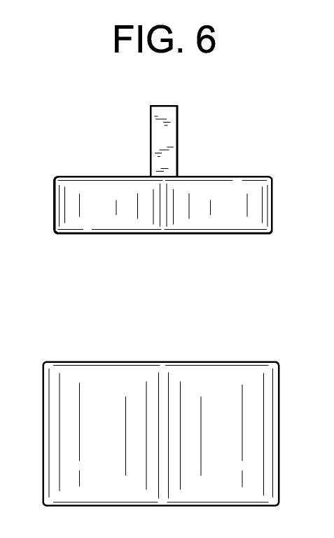

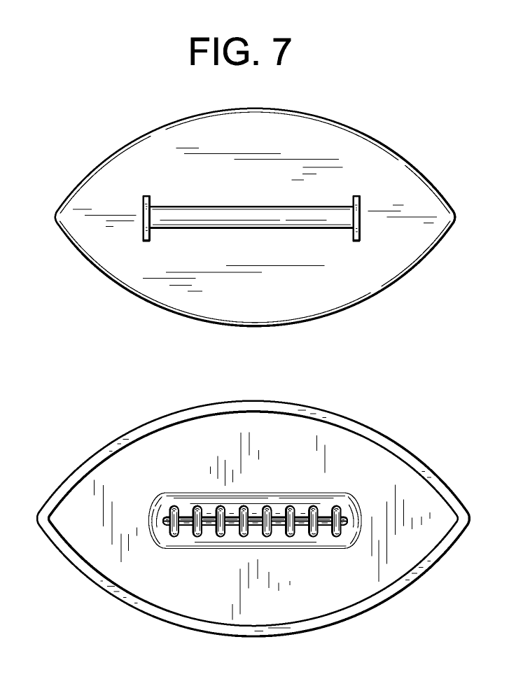

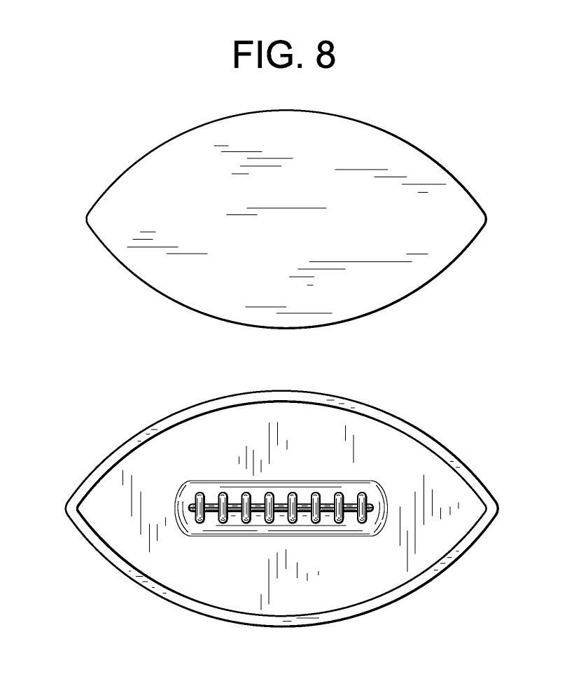

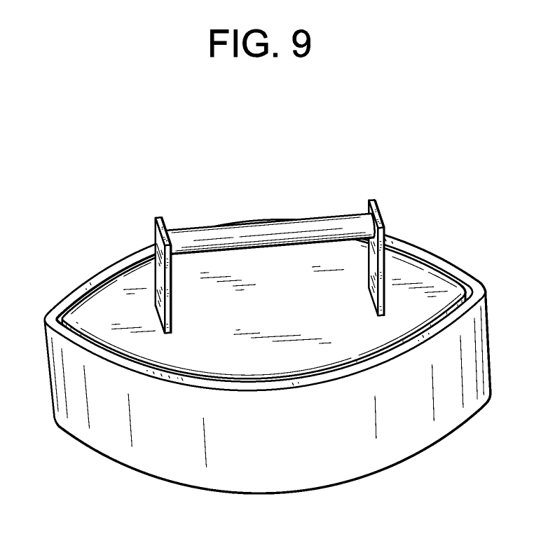

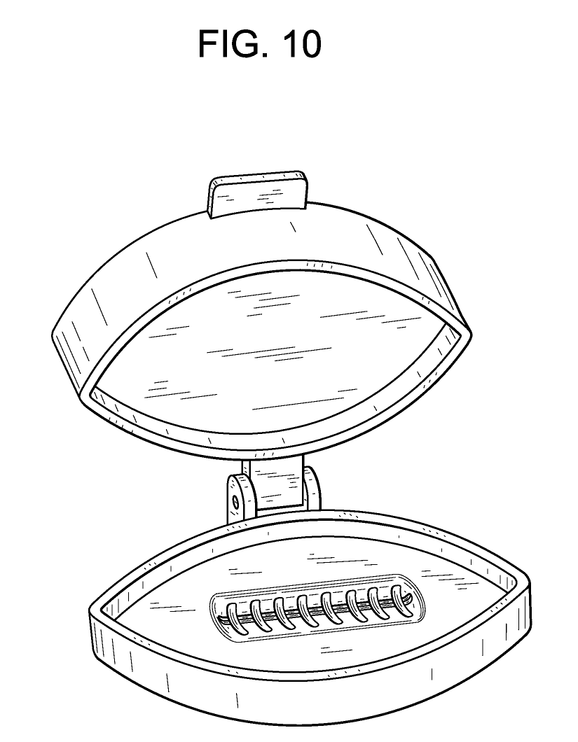

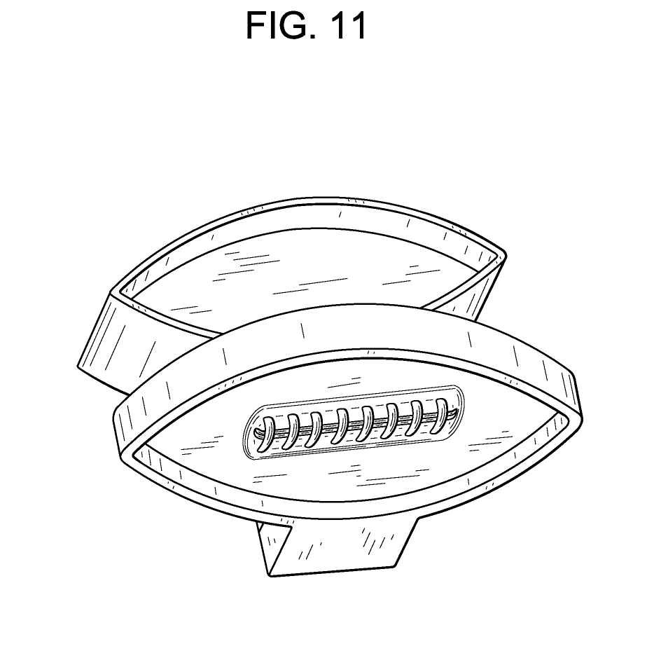

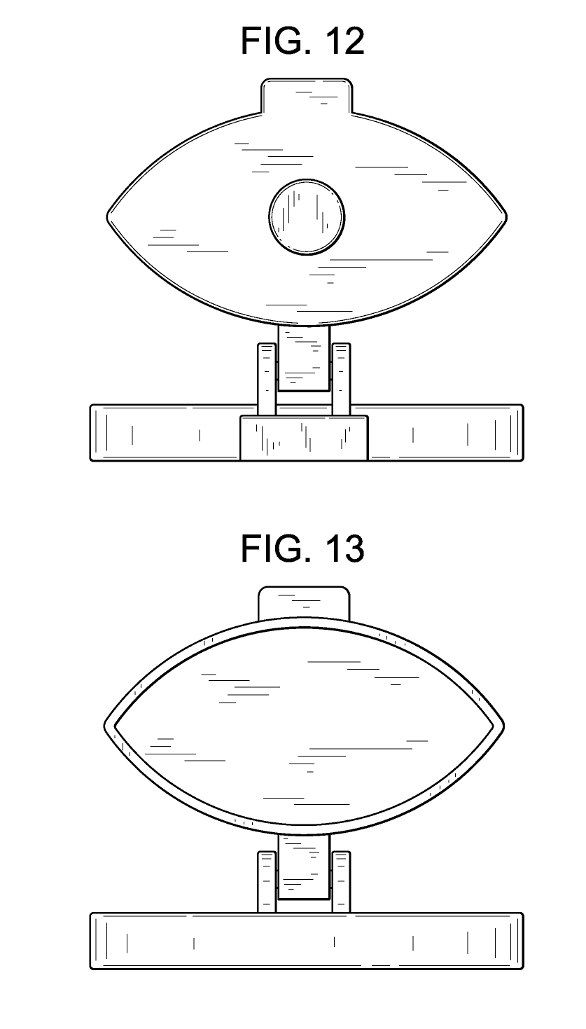

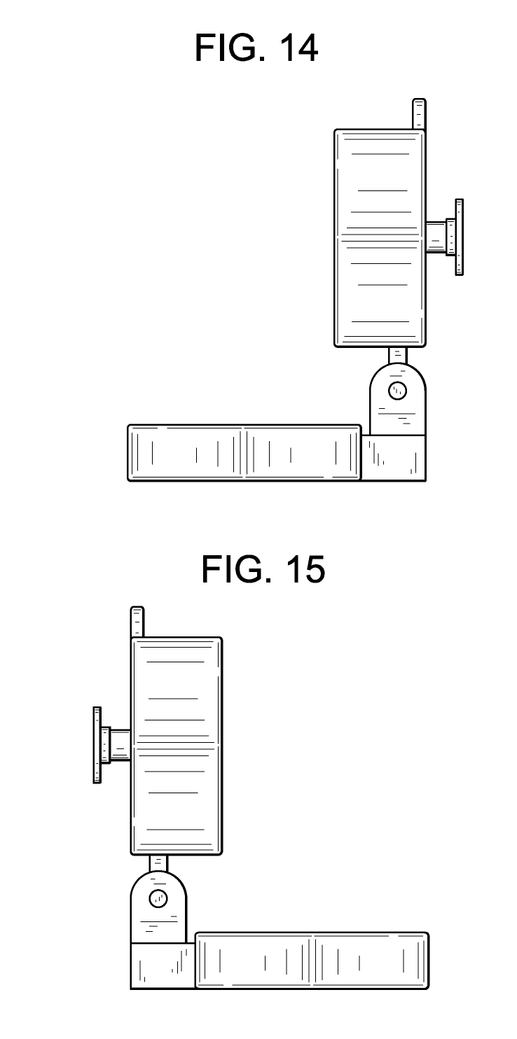

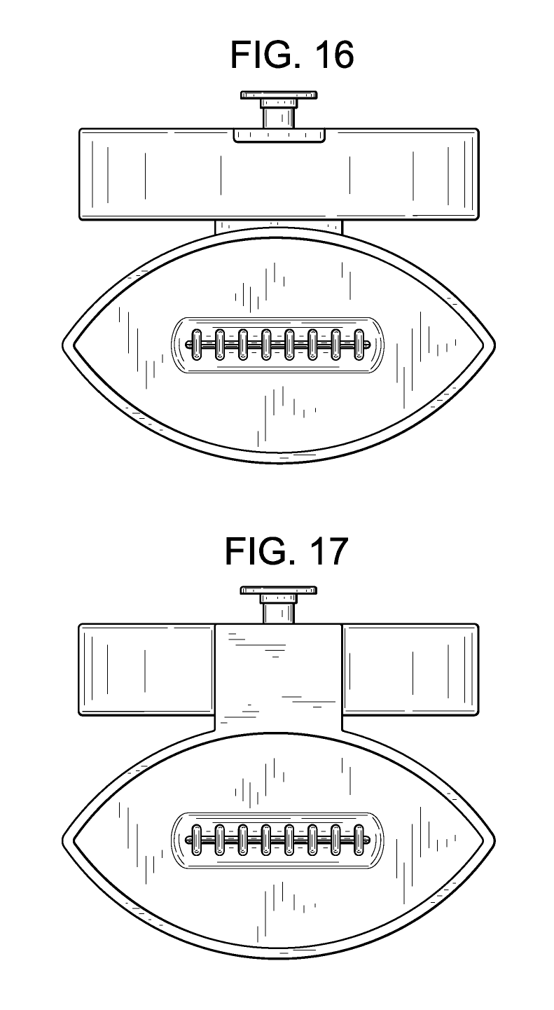

In an embodiment, the press imparts the design and shape of a football to a food, but the press itself is not limited to any particular shape or design. In another embodiment, the press itself is shaped and designed to look like a football. An example of an unhinged press of the present invention is shown in FIGS. 1-9, while an example of a hinged press of the present invention is shown in FIGS. 10-17.

In order to use the press, a ground food mix is placed on one side of the press (e.g., the base or the lid) and the base and lid are brought together in order to press the ground food mix therebetween, which compacts the ground food mix into a football shaped pressed food (e.g., a patty). Furthermore, the lid and base are to be moved toward each other until the imprint(s) on the base and/or lid contact the ground food mix and, with the application of firm pressure, impart thereon the football design.

The press can be made from nonstick, food grade, food safe material including but not limited to plastic, cast aluminum, stainless steel or other metal alloys (e.g., steel, brass, and cast iron). In another embodiment, the press is made using materials that are dishwasher safe.

The press may be designed as a two piece press that is unhinged (FIGS. 1-9) or it may be designed with a hinge that movably connects the base to the lid (FIGS. 10-17). In embodiments of both the hinged and unhinged designs, the press may further include a hand tab on the front of the lid that can be used to open and close the lid or a handle on the top of the lid to open and close the two pieces of the press.

The press may be designed to be used as a food press in order to prepare the football shaped pressed food prior to cooking and/or grilling. The press may also be designed for use during cooking and/or grilling. For example, the ground food may be added to the press in order to mold the ground food into a football shape (the press may also impart one or more of the designs described herein to the ground food), and the press may be used on a grill or in a pan to facilitate cooking and/or grilling of the football shaped pressed food. Alternatively, the press may be designed to be electrified in order to cook the food (e.g., a pressed food, such as a patty). The football shaped food press can be electrified in a manner similar to electrified appliances known in the art (see, e.g., U.S. Pat. Nos. 5,606,905; 6,016,741; 6,386,092; 6,427,581; 7,963,215, the disclosures of which are incorporated by reference in their entireties). Examples of electrified appliances include, but not limited to, a waffle maker, an electric food warmer, a panini press, a sandwich press, a GEORGE-FOREMAN™ grill, an electric Ebelskiver maker, and an electric cake maker.

The press may also be designed to be insulated, e.g., to keep the food (e.g., a pressed food, such as a patty) warm or cold prior to serving and/or cooking/grilling. In different aspects of the invention, the insulated and/or electrified press is portable and easily accessible at, e.g., a sporting event (e.g., tailgate parties, superbowl parties, high school football games, fundraisers, and pro-bowl parties).

### Types of Products Made by the Football Shaped Press

The football shaped press of the present invention may be used to prepare football shaped pressed food (e.g., a patty) using ground food. Ground food can include but is not limited to ground meats and/or seafood (e.g., ground beef, turkey, chicken, veal, goat, fish, shrimp, crab, and salmon), ground vegetables (e.g., lentils, beans, carrots, potatoes, yams, pumpkin, eggplant, cauliflower, chickpea, onions, garlic, and radish), rice products (e.g., white rice, brown rice, wild rice, glutinous rice, basmati rice, short grain rice, long grain rice, broken rice, and black rice), flour products (e.g., wheat flour, bread flour, rice flour, corn flour, buckwheat flour, potato flour, cake flour, soy flour, self-rising flour, and rye flour), and/or any combinations or mixtures thereof.

In some embodiments, the football shaped press may be used to prepare a football shaped pressed food, such as a tartare (e.g., steak tartare, venison tartare, tuna tartare, salmon tartare, chicken tartare, goat tartare, eel tartare, sole tartare, smelts tartare, and lamb tartare) and a baked good (e.g., cookies, cakes, muffins, pancakes, waffles, buns, turnovers, and pies). In one aspect, the design in the interior of the base and/or lid may be filled with a material (e.g., a filling) that is different from the ground food (e.g., a jam filling, e.g., strawberry jam, raspberry jam, peach jam e.g., a sauce filling, e.g., BBQ sauce e.g., a cream filling, e.g., pastry cream, chocolate cream, cream cheese e.g., a cheese filling, and/or an egg or egg-based filling). In another embodiment, the filling material may be placed in the interior of the football shaped pressed food during formation of the pressed food.

The pressed food (e.g., a patty) may be made ahead of time using the press and stored and/or frozen prior to cooking or grilling or the pressed food may cooked or grilled without storage and/or freezing. The press is sized so that the pressed food (e.g., patties, such as hamburger patties) made using the press will fit most commercial buns.

The press is designed to make a pressed food (e.g., a patty) of varied thickness, in particular, a patty having a thickness of less than or up to 1 ½ inches thick (e.g., a patty made with about ¹/4 lb, ½ lb, or ¾ lb of the ground food mix, such as the ground foods described herein, e.g., ground beef). The press is designed to be adjustable to allow for portion control. In one embodiment, the press produces consistent-sized pressed food products (e.g., patties) that allow for uniform cooking or grilling. In another embodiment, the pressed food (e.g., a patty) may be prepared and/or enjoyed at any football themed event.

### Types of Designs Produced in Food Prepared Using the Press

The press may be provided in the shape of a football or other shapes known in the art. Preferably the press is shaped to look like a football or to have features that resemble a football shape. Use of the press produces a pressed food (e.g., a patty) from a ground food that resembles a football. The press may further include designs on the interior surface of the base and/or lid that are imprinted onto the food during pressing that resemble other features of a football (e.g., the laces of the football, pebble-grain texture, and/or vertical stripes on each end of the football).

Alternatively, the press may impart, in addition to, or instead of, the football features previously noted, an imprint of a trademark logo or insignia (e.g., league or conference logos, such as a National Football League (NFL) or National Collegiate Athletic Association (NCAA) logo) to the surface of the food. Examples of NFL logos include but are not limited to, team names (e.g., Patriots, Colts, Giants, Pacers, Cowboys, Jets, Browns, Chargers, Ravens, Panther, Saints,

Buccaneers, Bills) and/or team logos (e.g., a lightning bolt, a start, a jaguar, a falcon, a panther, a raven, a lion, a C, a G, a viking, and a ram). Examples of NCAA logos include but are not limited to, team names (e.g., Boston College, Duke, Baylor, Montana, Oklahoma, Northwester, Wisconsin, Princeton, Yale, Harvard, Brown, Houston, Florida A&M, Brigham Young), and/or team logos (e.g., a longhorn, an alligator, a tiger, a lion, a duck, a beaver, an Irish, and a bear paw).

In one embodiment, the press imprints the logo or insignia and the additional football features (e.g., the laces, the pebble-grain texture, and/or the vertical stripes) onto one or both surfaces of the pressed food, such as a patty (e.g., the top and/or bottom of the pressed food). In another embodiment, the pressed food is stored or frozen prior to use (e.g., cooking or grilling). In still another embodiment, the press imprints the logo or insignia and the additional football features (e.g., the laces, the pebble-grain texture, and/or the vertical stripes) onto the surface of the pressed food during use (e.g., cooking or grilling). The imprint of the logo or insignia and additional football features are preferably raised on the football shaped pressed food (e.g., a patty) that is produced using the press but may also be indented into the pressed food (e.g., a patty).

In yet another embodiment, the press imparts a logo or insignia and/or a football feature (e.g., the laces, pebble-grain texture, and/or vertical stripes) onto the surface of a pressed food during cooking or grilling. In still another embodiment, the press is used to make a plurality of football shaped food products (e.g., patties) that may also include a logo or insignia and/or a football feature (e.g., the laces, pebble-grain texture, and/or vertical stripes) pressed onto the surface of the pressed food products (e.g., patties).

### OTHER EMBODIMENTS

While the invention has been described in connection with specific embodiments thereof, it will be understood that it is capable of further modifications and this application is intended to cover any variations, uses, or adaptations of the invention following, in general, the principles of the invention and including such departures from the present disclosure come within known or customary practice within the art to which the invention pertains and may be applied to the essential features hereinbefore set forth.

All publications, patents and patent applications are herein incorporated by reference in their entirety to the same extent as if each individual publication, patent or patent application was specifically and individually indicated to be incorporated by reference in its entirety.

What is claimed is:

1. A press for making a football shaped pressed food, comprising:
a) a base,
b) an opposing lid, and
c) a handle or hand tab positioned on said lid for closing said lid onto said base, wherein said base and/or lid are configured to mold a ground food into a football shape during pressing.

2. The press of claim 1, further comprising a hinge connecting said lid and said base.

3. The press of claim 1, wherein said base and/or lid of said press further comprises an interior surface that comprises an imprint that imparts one or more of the following designs onto a surface of said ground food during pressing: a sports logo, laces of a football, vertical stripes of a football, and a pebble-grain texture.

4. The press of claim 1, wherein said base is adjustable to allow for variations in the amount and/or thickness of said football shaped pressed food.

5. The press of claim 4, wherein the thickness of said football shaped pressed food is less than or up to 1 ½ inches.

6. The press claim 1, wherein said press is made from a food safe material.

7. The press of claim 6, wherein said food safe material is selected from the group consisting of plastic, cast aluminum, stainless steel, and metal alloys.

8. The press of claim 1, wherein said press is dishwasher safe.

9. The press of claim 1, wherein said press produces said football shaped pressed food of a uniform size.

10. The press of claim 1, wherein said football shaped pressed food is sized to fit a commercial bun.

11. The press of claim 1, wherein said football shaped pressed food is a patty.

12. The press of claim 1, wherein said ground food is selected from the group consisting of meats, seafood, vegetables, rice products, flour products, and any combinations or mixtures thereof.

13. The press of claim 12, wherein said ground food comprises beef, turkey, chicken, veal, goat, fish, shrimp, crab, salmon, lentils, beans, carrots, potatoes, yams, pumpkin, eggplant, cauliflower, chickpea, onions, garlic, radish, white rice, brown rice, wild rice, glutinous rice, basmati rice, short grain rice, long grain rice, broken rice, black rice, wheat flour, bread flour, rice flour, corn flour, buckwheat flour, potato flour, cake flour, soy flour, self-rising flour, or rye flour.

14. The press of claim 1, wherein said football shaped pressed food is a tartare or a baked good.

15. The press food of claim 14, wherein said football shaped pressed food is a steak tartare, a venison tartare, a tuna tartare, a salmon tartare, a chicken tartare, a goat tartare, an eel tartare, a sole tartare, a smelt tartare, a lamb tartare, a cookie, cake, muffin, pancake, waffle, bun, turnover, or a pie.

16. The press food of claim 14, wherein said football shaped pressed food further comprises a filling material.

17. The press of claim 1, wherein said press is shaped and/or designed to resemble a football.

18. A method for making a football shaped food patty, comprising
a) placing the ground food in the press of claim 1, and
b) compressing the ground food between said base and lid of said press to form said football shaped pressed food.

19. The method of claim 18, wherein said football shaped pressed food is a patty.
